(19) United States
(12) Patent Application Publication
(10) Pub. No.: US 2009/0055137 A1
(43) Pub. Date: Feb. 26, 2009

(54) METHOD FOR OBTAINING GEOMETRIC PROPERTIES OF AN ANATOMIC PART

(76) Inventors: Imed Gargouri, Montreal (CA); Jacques A. DeGuise, Montreal (CA)

Correspondence Address: OGILVY RENAULT LLP, 1981 MCGILL COLLEGE AVENUE, SUITE 1600, MONTREAL, QC, H3A2Y3, CA

(21) Appl. No.: 12/196,636

(22) Filed: Aug. 22, 2008

Related U.S. Application Data
(60) Provisional application No. 60/957,290, filed on Aug. 22, 2007.

(51) Int. Cl. G06F 17/50; G06F 17/10

(52) U.S. Cl. 703/1

(57) ABSTRACT

The method provides a way to obtain geometric properties of an anatomic part defined in a model representing the actual anatomic part in a computer or the like. The geometric properties are calculated using analytic-function parameter values of a plurality of basic-geometry items forming an analytic representation approximating the anatomic part. The analytic-function parameter values are computed by performing an optimization technique.

### CROSS-REFERENCE TO RELATED APPLICATION

The present application claims the benefit of U.S. provisional patent application No. 60/957,290 filed Aug. 22, 2007, the entire contents of which is hereby incorporated by reference.

### TECHNICAL FIELD

The technical field relates generally to the obtention of geometric properties of an anatomic part of a human or another animal.

### BACKGROUND

Knowing geometric properties of an anatomic part can be very useful in many areas of medicine. These geometric properties can, for example, assist in establishing a diagnosis, estimating a pathology, planning a surgery, designing a custom-made prosthesis, conducting a biomechanical analysis, etc. Geometric properties can also be useful in other fields such as anthropology, forensic science, statistical studies, etc.

Bones are examples of anatomic parts for which someone may want to obtain geometric properties indicative of the bone morphology. For instance, to improve or verify the final result of an intervention, a practitioner often needs to obtain at least some clinical or morphologic information on the bone or bones of the patient. Such information can be obtained by performing a morphologic analysis, which often requires manual or semi-manual measurements to gather the appropriate data about the bone or bones. The measurements can be taken directly on the patient or on an image representing the bone or bones of interest. However, finding clinical or morphological landmarks on a patient or in an image can be challenging.

To track landmarks, experienced technicians or practitioners must manually locate physical or visual references, even when tools are provided to assist them. The accuracy of the measurements, which can also be very time consuming, depends largely on the accuracy in the identification of the right landmarks. This process is subject to imprecision, even when using computerized pointer tools or other semi-automatic tools are used, at least because different persons may have different opinions on where the landmarks are. There are often variations even when it is the same person that does the identification. Still, some landmarks can be hidden or be not clearly visible on a patient or in an image.

Problems similar to those mentioned above are also experienced with other anatomic parts. Clearly, room for improvements in obtaining geometric properties of an anatomic parts exists.

### SUMMARY

In one aspect, there is provided a method for obtaining geometric properties of an anatomic part defined in a model, the method comprising: performing an optimization technique to obtain analytic-function parameter values of a plurality of basic-geometry items forming an analytic geometry representation approximating the anatomic part, the analytic-function parameter values being computed until the basic-geometry items are positioned and proportioned within the analytic geometry representation to substantially correspond to the anatomic part in the model; and calculating the geometric properties using at least some of the analytic-function parameter values.

In another aspect, there is provided a system for carrying out a method for obtaining geometric properties of an anatomic part defined in a model, as shown and described herein.

In a further aspect, there is provided a computer readable storage medium encoded with a computer program for controlling the operation of a system carrying out a method for obtaining geometric properties of an anatomic part defined in a model, as shown and described herein.

Further details on these as well as other aspects of the improvements will be apparent from the following detailed description and figures.

### BRIEF DESCRIPTION OF THE FIGURES

For a better understanding and to show more clearly how the improvements presented herein may be carried into effect, reference will now be made by way of example to the accompanying figures, in which:

FIG. 1 is an example of a mesh illustration of a polyhedral model of a distal femur;

FIG. 2 is a schematic isometric view showing an example of the spatial distribution of basic-geometry items that can be used for representing a proximal femur;

FIGS. 3A to 3D are schematic elevation views showing examples of radial constraints variables for improving the stability in an energy-cost function;

FIG. 4 is a schematic view showing an example of a simpler analytic geometry representation for the proximal tibia that can be initially used in the method;

FIGS. 5A and 5B illustrate an example of a rearrangement/reorientation of a model for a distal femur along the Z axis before the optimization; FIG. 6 shows an example of basic-geometry items forming an analytic geometry representation that can be used for approximating a 2-D femur;

FIG. 7 is a view similar to FIG. 6, showing examples of possible geometric properties for a femur in 2-D;

FIG. 8 is a block diagram showing a broad overall view of an example of the method;

FIG. 9 shows an example of surfaces under the lateral and medial condyles of a distal femur for which two virtual reference points are provided to calculate some of the geometric properties; and

FIGS. 10 and 11 are views illustrating other examples of geometric properties that can be obtained using the new approach.

### DETAILED DESCRIPTION

The improved method presented herein is used to calculate geometric properties of an anatomic part defined in a model. It should be noted that the expression “anatomic part” is intended to broadly refer to an entire organ, a portion of an organ or even two or more adjacent organs and/or portions of organs forming a unit for which obtaining geometric properties can be useful. The anatomic part can be that of a human or any other animal, living or diseased. Also, the expression “geometric property” is intended to broadly refer to an information, for instance numerical, visual or other, which can represent the identification of a location of interest, for instance a specific point (such as a vertex or a center), an axis (such as a geometric axis or a clinical axis), a line, a curve, a surface (such as an articulation surface), etc, or which can represent a measured parameter, for instance a length, a distance, an angle, an area, a volume, etc. Morphologic information, morphometric information and clinical information are three examples among many possible examples of geometric properties.

In the improved method, two-dimensional (2-D) or three-dimensional (3-D) data representing the anatomic part is first obtained using one or more of the numerous imagery techniques that are available. Obtaining 2-D data can be useful to have information on the contours of or within the anatomic part. Obtaining 3-D data can be useful to have information on surfaces around or within the anatomic part. Furthermore, it is also possible to use 3-D data to extract 2-D data about the anatomic part.

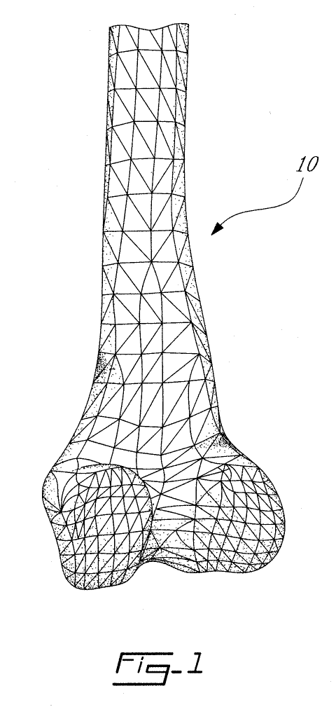

The data about the anatomic part is stored in what is called a “model”. The word “model” is intended to broadly refer to a set of 2-D and/or 3-D data obtained so as to represent the actual anatomic part in a computer or the like. There are also many possible ways of storing data in a model, for instance by using coordinates of a multitude of individual points and/or by using vertices and polygons representing a 3-D surface with multiple polyhedrons, as shown in the example depicted in FIG. 1. FIG. 1 is a mesh illustration 10 of a polyhedral model of a distal femur. Other ways of recording data in a model also exist.

To solve the challenge of obtaining one or more geometric parameters from a model using only a computer or the like, the improved method proposes a new approach involving the use of an analytic geometry representation. This analytic representation is provided so as to approximate the shape of the anatomic part for which the geometric properties are to be obtained. Values of analytic-function parameters of this analytic geometry representation are then used to calculate the geometric properties of interest.

The analytic geometry representation is in the form of a mathematical model having a plurality of basic-geometry items, such as points, lines, circles, spheres, cylinders, quadratics and superquadratics, etc. When blended together, the basic-geometry items form an algebraic surface S. The blending can be expressed as a union, an intersection, a subtraction or a combination thereof. The union, intersection and subtraction operators can be respectively expressed, for example, as follows:

∪(F₁,F₂ , . . . , Fₙ)=(F₁^{-m}+F₂^{-m}+ . . . +Fₙ^{-m})⁻¹ (1 )

∩(F₁, F₂, . . . , Fₙ)=F₁^{m}+F₂^{m}+ . . . +Fₙ^{m} (2)

F₁₋₂=F₁^{m}+F₂^{-m} (3)

An analytic geometry representation approximating the anatomic part in 3-D can be expressed as:

S{P(x,y,z) ∈ R³/f(x,y,z,p)≦s} (4)
where x, y, z are space coordinates, for example Cartesian coordinates, cylindrical coordinates, spherical coordinates, etc;
s is the threshold;
p is the parameters of the basic-geometry items; and
R represents the 3-D space.

An analytic geometry representation approximating the anatomic part in 2-D can be expressed as:

S={P(x,y) ∈ R²/f(x,y,p)≦s} (5)
where x, y are space coordinates, for example Cartesian coordinates, cylindrical coordinates, spherical coordinates, etc;
s is the threshold;
p is the parameters of the basic-geometry items; and
R represents the 2-D space.

The number of basic-geometric items depends for instance on the complexity of the anatomic part and on the geometric properties that need to be obtained.

In use, data from the model can be sent to a computer for an analysis. The computer compares the data to the analytic geometry representation chosen to approximate the anatomic part of interest. The analytic geometry representation can be previously programmed or otherwise recorded in a database. The computer will be used to position and proportion the basic-geometry items within the analytic geometry representation by computing the analytic-function parameter values until the basic-geometry items substantially correspond to the anatomic part in the model. The analytic-function parameter values may include, for instance, values of the radius of a sphere, the height of a cylinder, the dimensions of a polygon, etc.

Unlike what can be done using an image from a 3-D surface reconstruction of an anatomic part in the model, the analytic geometry representation can be used to calculate coordinates of landmarks within the analytic geometry representation. These coordinates can then be used to find the exact coordinates in the 3-D model data, using for instance a statistical analysis or any other techniques to find the best possible correlation between a point in the analytic geometry representation and a corresponding point in the model.

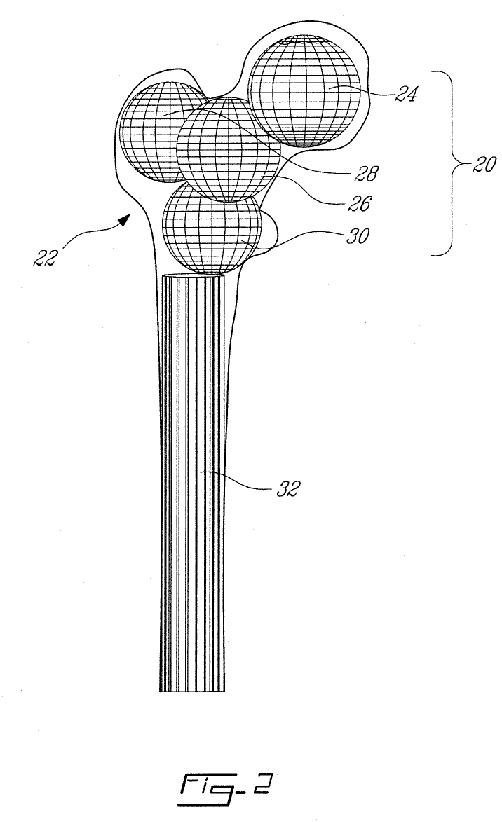

FIG. 2 is a schematic view showing an example of the spatial distribution of basic-geometry items of an analytic geometry representation 20 of a proximal femur 22. As can be seen, four spheres 24, 26, 28, 30 are combined with one elliptic cylinder 32 to represent the proximal femur 22 in the analytic geometry representation 20. The first sphere 24 is at the femoral head. The second sphere 26 is located into the neck. The third sphere 28 and the fourth sphere 30 are located respectively into the greater trochanter and lesser trochanter of the proximal femur 22. The cylinder 32 is located in the diaphysis region, with the Z axis being oriented parallel to the longitudinal axis of the diaphysis.

Similarly, four spheres and one elliptic cylinder can be used to describe the distal femur part. Three spheres and one elliptic cylinder are used to represent each proximal and distal tibia parts.

The following table summarizes these possible examples for the femur and the tibia:

| Anatomic | Anatomic | Basic-geometry | Unknown analytic- | | |
|---|---|---|---|---|---|
| parts | zones | items | function parameters | Nb. | Total |
| Proximal femur | Diaphysis | Elliptic cylinder | G_{c}(x_{c}, y_{c}, z_{c}, r_{xc}, r_{yc}, r_{zc}) | 6 | 22 |
| | Femoral head | Sphere | Gₛ₁(xₛ₁, yₛ₁, zₛ₁, rₛ₁) | 4 | |
| | Neck | Sphere | Gₛ₂(xₛ₂₁, yₛ₂, zₛ₂, rₛ₂) | 4 | |
| | Greater trochanter | Sphere | Gₛ₃(xₛ₃, yₛ₃, zₛ₃, rₛ₃) | 4 | |
| | Lesser trochanter | Sphere | Gₛ₄(xₛ₄, yₛ₄, zₛ₄, rₛ₄₁) | 4 | |
| Distal femur | Diaphysis | Elliptic cylinder | G_{c}(x_{c}, y_{c}, z_{c}, r_{xc}, r_{yc}, r_{zc}) | 6 | 22 |
| | Posterior lateral | Sphere | Gₛ₁(xₛ₁, yₛ₁, zₛ₁, rₛ₁) | 4 | |
| | condyle | | | | |
| | Anterior lateral | Sphere | Gₛ₂(xₛ₂₁, yₛ₂, zₛ₂, rₛ₂) | 4 | |
| | condyle | | | | |
| | Posterior medial | Sphere | Gₛ₃(xₛ₃, yₛ₃, zₛ₃, rₛ₃) | 4 | |
| | condyle | | | | |
| | Anterior medial | Sphere | Gₛ₄(xₛ₄, yₛ₄, zₛ₄, rₛ₄₁) | 4 | |
| | condyle | | | | |
| Proximal tibia | Diaphysis | Elliptic cylinder | G_{c}(x_{c}, y_{c}, z_{c}, r_{xc}, r_{yc}, r_{zc}) | 6 | 18 |
| | Internal condyle | Sphere | Gₛ₁(xₛ₁, yₛ₁, zₛ₁, rₛ₁) | 4 | |
| | External condyle | Sphere | Gₛ₂(xₛ₂, yₛ₂, zₛ₂, rₛ₂) | 4 | |
| | Tuberosity | Sphere | Gₛ₃(xₛ₃, yₛ₃, zₛ₃, rₛ₃) | 4 | |
| Distal tibia | Diaphysis | Elliptic cylinder | G_{c}(x_{c}, y_{c}, z_{c}, r_{xc}, r_{yc}, r_{zc}) | 6 | 18 |
| | Malleolus | Sphere | Gₛ₁(xₛ₁, yₛ₁, zₛ₁, rₛ₁) | 4 | |
| | Posterior face | Sphere | Gₛ₂(xₛ₂, yₛ₂, zₛ₂, rₛ₂) | 4 | |
| | Anterior face | Sphere | Gₛ₃(xₛ₃, yₛ₃, zₛ₃, rₛ₃) | 4 | |

The same general approach also applies to other anatomic parts.

Referring back to the proximal femur, the algebraic surface S of the analytic geometry representation can be expressed as:

$$S = {\{ \begin{matrix}{[ {( {( \frac{x - {x}_{c}}{{r}_{xc}} )}^{2} + {( \frac{y - {y}_{c}}{{r}_{yc}} )}^{2} )}^{8} + {( \frac{z - {z}_{c}}{{r}_{zc}} )}^{16} ]}^{- 2} + \\ {[ {( \frac{x - {x}_{s 1}}{{r}_{s 1}} )}^{2} + {( \frac{y - {y}_{s 1}}{{r}_{s 1}} )}^{2} + {( \frac{z - {z}_{s 1}}{{r}_{s 1}} )}^{2} ]}^{- 2} + \\ {[ {( \frac{x - {x}_{s 2}}{{r}_{s 2}} )}^{2} + {( \frac{y - {y}_{s 2}}{{r}_{s 2}} )}^{2} + {( \frac{z - {z}_{s 2}}{{r}_{s 2}} )}^{2} ]}^{- 2} + \\ {[ {( \frac{x - {x}_{s 3}}{{r}_{s 3}} )}^{2} + {( \frac{y - {y}_{s 3}}{{r}_{s 3}} )}^{2} + {( \frac{z - {z}_{s 3}}{{r}_{s 3}} )}^{2} ]}^{- 2} + \\ {[ {( \frac{x - {x}_{s 4}}{{r}_{s 4}} )}^{2} + {( \frac{y - {y}_{s 4}}{{r}_{s 4}} )}^{2} + {( \frac{z - {z}_{s 4}}{{r}_{s 4}} )}^{2} ]}^{- 2} +\end{matrix} \}}^{- 1} \qquad ( 6 )$$

where x_{c}, y_{c}, z_{c}, are the Cartesian coordinates of the center of the cylinder,
r_{xc}, r_{yc}, r_{zc}, are the radii of the cylinder (r_{zc} being the height)
xₛ₁, yₛ₁, zₛ₁, are the Cartesian coordinates of the center of the first sphere
rₛ₁, is the radius of the first sphere
etc.

The first part of equation 6, which corresponds to the elliptic cylinder in the analytic geometry representation, have power factors (8 and 16) that were chosen to better approximate the opposite end surfaces of the cylinder. These end surfaces are not perfectly planar surfaces in an analytic geometry equation. Other power factors or even other analytic representations can be used selected if desired.

Of course, other kinds of basic-geometry items than those defined in equation 6 can be used in an analytic geometry representation, depending on the anatomic part and the required precision. In some cases, the basic-geometry items can be all identical (for instance, only spheres). It is also possible to provide more than one possible analytic geometry representation for the same anatomic part and select the one that is the most appropriate according to the geometric properties to obtain.

The various analytic geometry equations of basic-geometry items can be found in references such as “Analytic Geometry”, by Douglas R. Riddle, Brooks Cole, 6th edition, 1995; and “Implicit Objects Computer Graphics”, by Luiz Velho, Jonas Gomes and Luiz H. de Figueiredo, Springer, 1st edition, 2002, the entire contents of both of these reference being hereby incorporated by reference.

In the case of a proximal femur defined in a 3-D model by M(P, N) and analytically represented by the algebraic surface S, where P represents a set of surface points and N is a set of normal vectors calculated on each point of P, the goal is to estimate the values of the analytic-function parameters Gₛ of S:

Gₛ=((x_{c},y_{c},z_{c},r_{xc},r_{yc},r_{zc}), (xₛ₁,yₛ₁,zₛ₁,rₛ₁), (xₛ₂,yₛ₂,zₛ₂,rₛ₂), (xₛ₃,yₛ₃,zₛ₃,rₛ₃)) (7)

The function to minimize is a geometric-distance error that can be written as:

E_{g}=∥P−S∥² (8)

The better a point P belongs to the algebraic surface S, the closer the geometric distance E_{g} will be to the minimum. In some cases, more constraints can be added. For example, in order to improve stability to the energy-cost function, two additional terms Eₙ and Eᵣ can be incorporated. Eₙ can be defined as:

Eₙ=∥∇SN−1∥² (9)

where N is a set of normal vectors calculated on each point of P and ∇S is a quadric-surface gradient of the algebraic surface S. Normal-energy term Eₙ pushes ∇S to be in same direction as N. Second term Eᵣ introduces radial constraints and is defined as variance data of Gₛ:

Eᵣ=var(r_{c},rᵢ) (10)

Eᵣ imposes stability between the spheres and the cylinder of the proximal femur example and also avoids high difference between radius sizes. In that case, Eᵣ can be expressed as:

Eᵣ=(∥S₁−S₂∥²−(r₁+r₂)²)²+(∥S₂S₃∥²−(r₂+r₃)²)²(∥S₁−S₃∥²−(r₁+r₃)²)² (11)

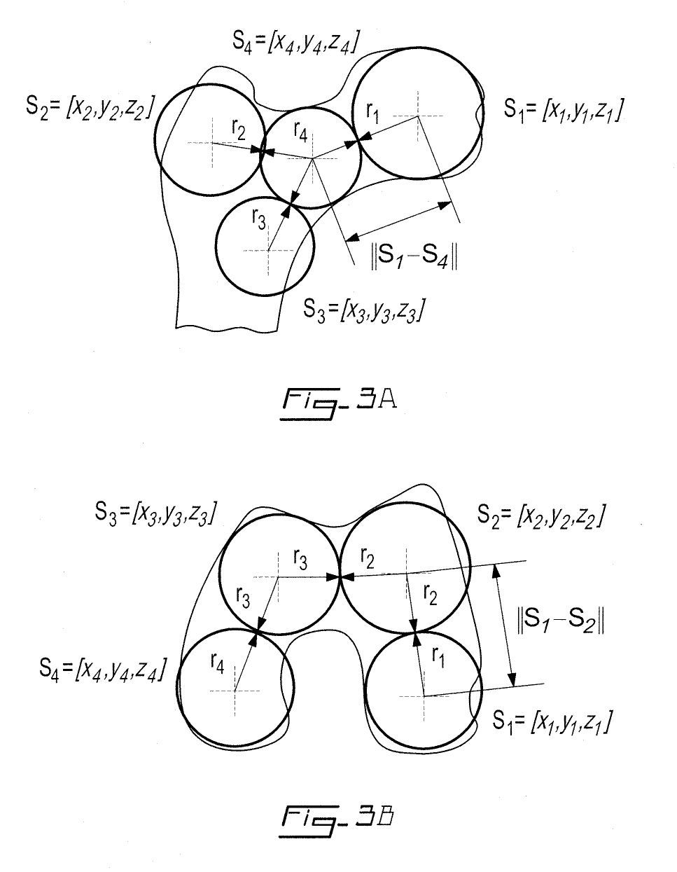

FIG. 3A illustrates the above-mentioned example.

FIG. 3B illustrates an example of variables for Eᵣ in the case of a distal femur. In that case, Eᵣ can be expressed as:

Eᵣ=∥S₁−S₂∥²−(r₁+r₂)²)²+(∥S₂−S₃∥²−(r₂+r₃)²)²(∥S₃−S₄∥²−(r₃+r₄)²)² (12)

FIGS. 3C and 3D illustrate examples of variables for Eᵣ in the case of a proximal tibia and a distal tibia, respectively. In both cases, Eᵣ can be expressed as:

Eᵣ=(∥S₁−S₂∥²−(r₁+r₂)²)²+(∥S₂S₃∥² −(r₂+r₃)²)²(∥S₁−S₃∥²−(r₁+r₃)²)² (13)

The global minimization function can be formulated as:

E(M,S)=min(αE_{g}+βEₙ+γEᵣ) (14)
where α, β and γ are weight factors between 0 and 1 that are selected for a given anatomic part.

The above-mentioned equations are only examples among many possible ones and in some cases, other constraints can be used or no constraint can be necessary.

Finding values for the various analytic-function parameters is performed using an optimization technique. There are several optimization techniques that can be used. Such optimization techniques are disclosed in many references, such as “Engineering Optimization: Theory and Practice”, 3rd Edition, by Singiresu S. Rao, Wiley-Interscience, 1996; “Practical Methods of Optimization”, by R. Fletcher, Wiley; 2nd edition, 2000; “Engineering Optimization: Methods and Applications”, by A. Ravindran, K. M. Ragsdell and G. V. Reklaitis, Wiley; 2nd edition, 2006; and “Optimization Concepts and Applications in Engineering”, by Ashok D. Belegundu and Tirupathi R. Chandrupatla, Prentice Hall, 1999, the entire contents of all of these reference being hereby incorporated by reference.

The Levenberg-Marquardt optimization technique is one possible nonlinear optimization that can be used to compute the analytic-function parameter values. This technique, however, can be sensitive to the initial solution and its convergence can sometimes be compromised, particularly when the energy function to be optimized is complex with several local minima. To accurately reach a global solution, it is possible to use a coarse-to-fine optimization strategy based on low to high analytic-resolution functions.

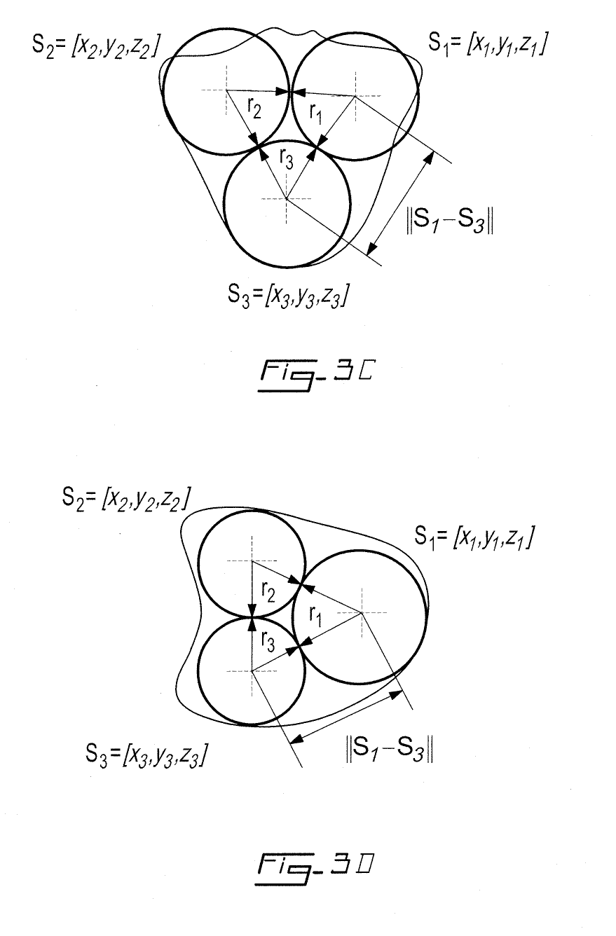

A simpler analytic geometry representation can be first used to more coarsely correspond to the anatomic part with less basic-geometry items. For instance, as shown in FIG. 4, one can use a simpler analytic geometry representation 40 having only one right circular cylinder 42 and one sphere 44 for coarsely approximating the proximal femur. The algebraic surface S of this simpler analytic geometry representation 40 can be expressed as:

$${S}_{simpler} = {\{ \begin{matrix}{[ {( \frac{x - {x}_{c}}{{r}_{c}} )}^{2} + {( \frac{y - {y}_{c}}{{r}_{c}} )}^{2} ]}^{- 2} + \\ {[ {( \frac{x - {x}_{s}}{{r}_{s}} )}^{2} + {( \frac{y - {y}_{s}}{{r}_{s}} )}^{2} + {( \frac{z - {z}_{s}}{{r}_{s}} )}^{2} ]}^{- 2}\end{matrix} \}}^{- 1} \qquad ( 15 )$$

Reducing the number of unknown analytic parameters in the energy function allows the Lavenberg-Marquartd optimization algorithm to converge accurately to a coarse-global solution. The coarse-global solution Gₛ can then be used to estimate the initial analytic-function parameter values for the optimization of the fine analytic geometry representation by dividing a coarse basic-geometric item into subparts and using these subparts (or the coordinates thereof) to pre-position at least some of the basic-geometry items in the fine analytic geometry representation.

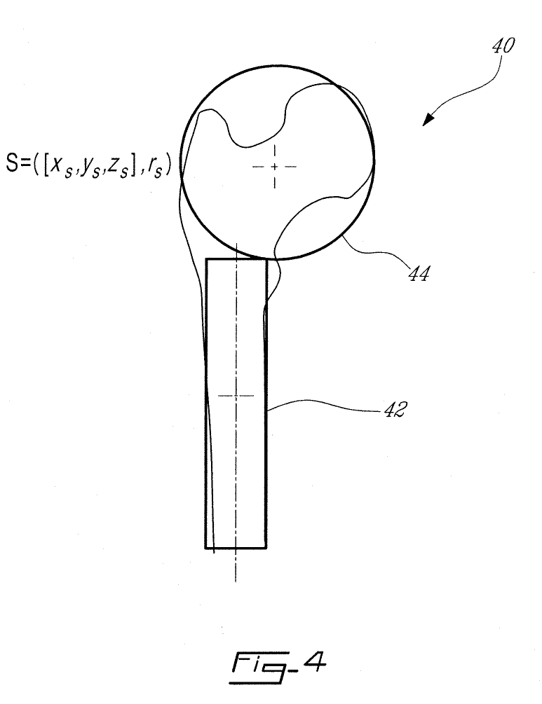

Before the optimization, data in the model can be rearranged and/or reoriented. For instance, the model data can be align according to its inertia moments. In the case of the proximal (or distal) femur, the Z axis in the model data can be aligned with the diaphysis. FIGS. 5A and 5B illustrate an example of such reorientation of the data in the model. Other ways of rearranging and/or reorienting the data can be used as well.

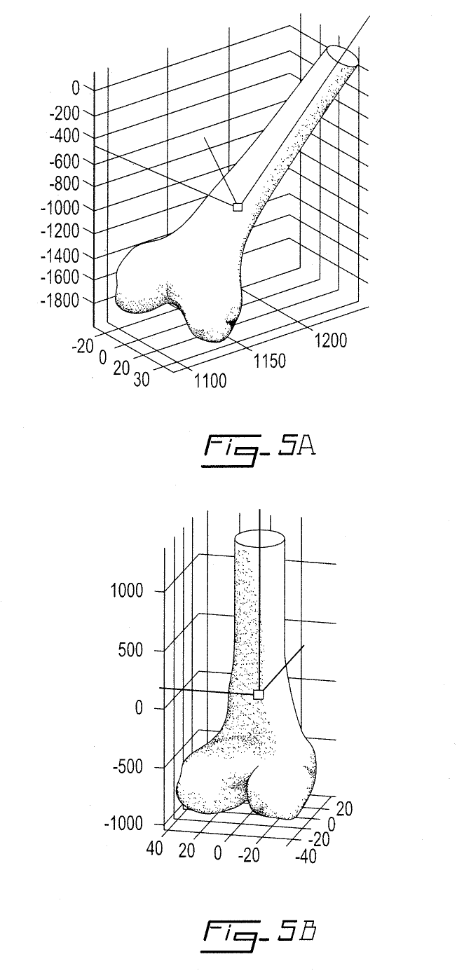

FIG. 6 shows an example of 2-D basic-geometry items comprising circles and a line forming an analytic geometry representation 50 approximating a complete femur in 2-D. Examples of possible geometric properties are depicted in FIG. 7.

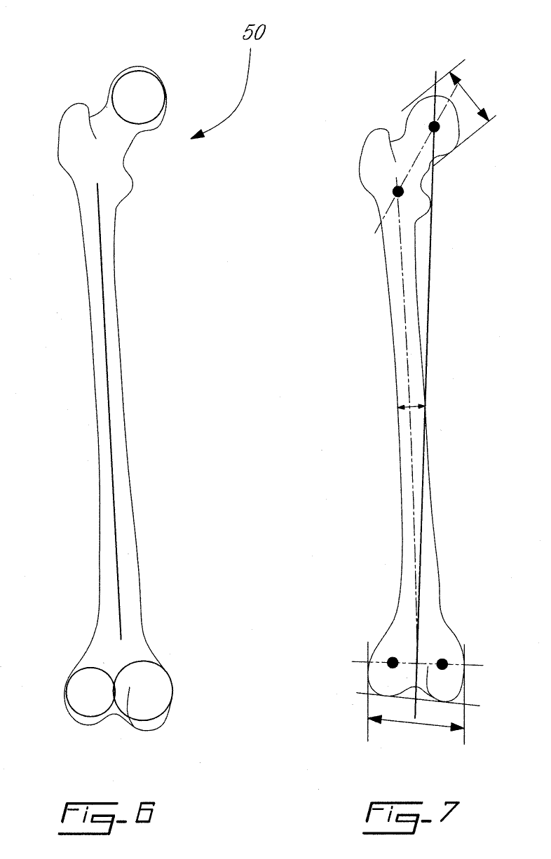

FIG. 8 a block diagram showing a broad overall view of an example of the method.

To calculate the geometric properties using the analytic-function parameter values, the computer must be initially provided with what is referred to hereafter as the “heuristic plans”. Simply stated, the heuristics plans are information programmed or otherwise recorded in a memory or database that act as maps allowing the computer to find landmarks in the model data using the analytic-function parameter values. For example, such heuristic plans can be ways for finding intersections between two geometric-geometry items, the centers of surfaces, the mid-point between two main axes, etc. This way, once the analytic-function parameter values are known, the computer can automatically determine the landmarks in the analytic geometry representation and then the geometric properties from the model data of the anatomic part.

If desired, each anatomic region within the data model can be separately detected and limit zones tracked. The heuristic plans use the geometric spatial data of the analytic geometry representation to locate the geometric properties. The geometric properties can be obtained using the geometric spatial data alone or using both the geometric data and the model data. To compute subsequently landmarks relative to axis, curves, surfaces, and anatomic regions, complex heuristic plans can be provided using previously-located geometric properties. Each plan can be expressed as a cost function that involves geometric, radial and normal constraints, and/or any suitable mathematic or topologic descriptor.

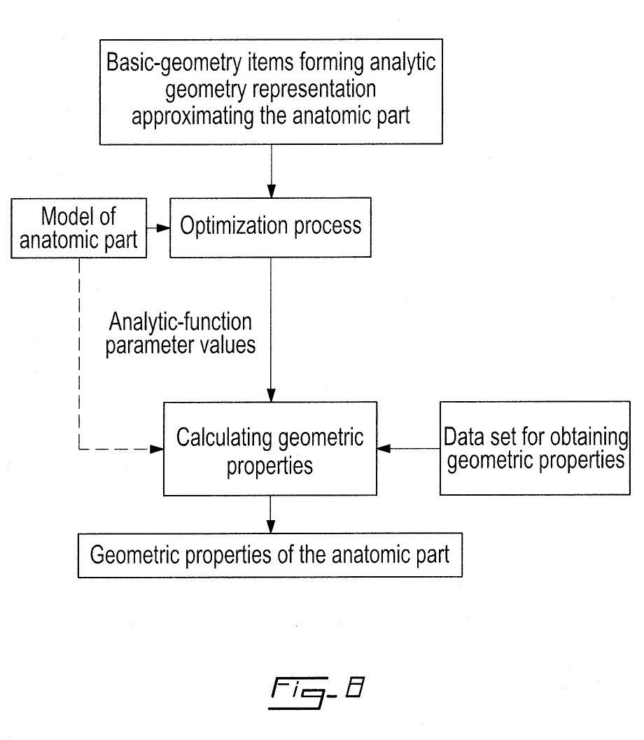

Still, it is possible to calculate at least one of the geometric properties using at least one virtual reference point that was calculated using at least one of the analytic-function parameter values from the fine analytic geometry representation. As shown in an example illustrated in FIG. 9, which shows surfaces under the lateral and medial condyles of a distal femur 60, it is possible to provide two virtual reference points 62, 64, in this case outside the surface of the distal femur 60, that can act as centers of projections. These centers of projections can allow positioning the articular boundaries 66, 68 after calculating a series of points on the boundaries. The two illustrated virtual reference points 62, 64 can be calculated using the centers of the spheres in the analytic geometry representation of the distal femur 60. The two virtual reference points can then be positioned at a known distance from the sides.

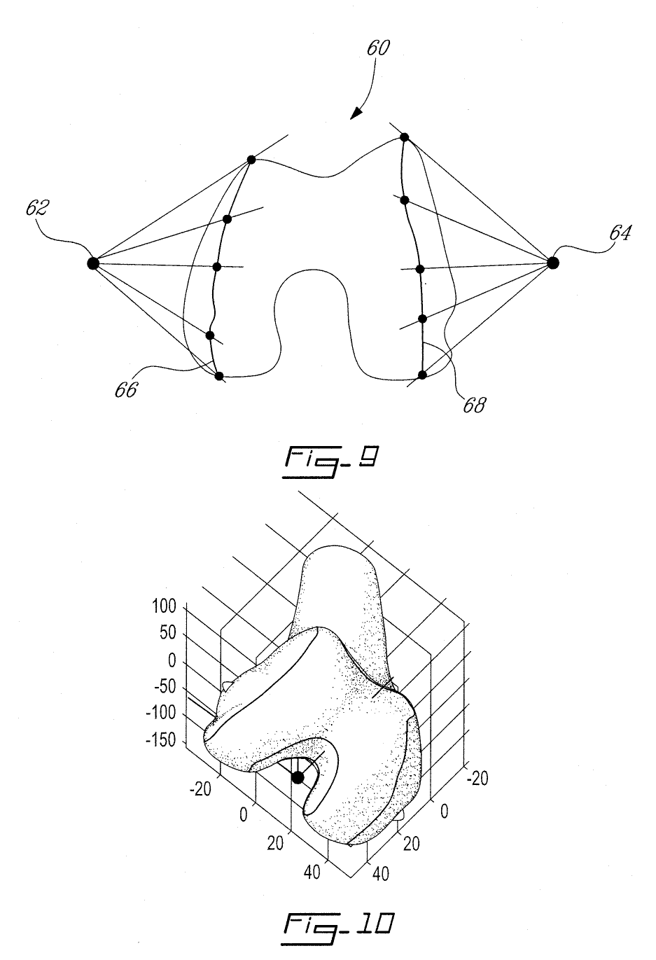

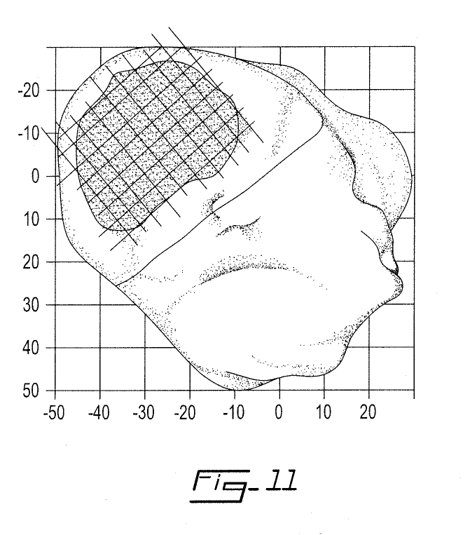

FIGS. 10 and 11 are views illustrating other examples of geometric properties that can be obtained using the new approach.

As can be appreciated, the new approach described herein is applicable to a very wide range of anatomic parts and can greatly improve the accuracy as well as the speed for obtaining geometric properties of the anatomic parts.

It should be noted that various modifications which fall within the scope of the present description will be apparent to those skilled in the art, in light of a review of the disclosure, and such modifications are intended to fall within the appended claims.

1. A method for obtaining geometric properties of an anatomic part defined in a model, the method comprising:
performing an optimization technique to obtain analytic-function parameter values of a plurality of basic-geometry items forming an analytic geometry representation approximating the anatomic part, the analytic-function parameter values being computed until the basic-geometry items are positioned and proportioned within the analytic geometry representation to substantially correspond to the anatomic part in the model; and
calculating the geometric properties using at least some of the analytic-function parameter values.

2. The method as defined in claim 1, wherein calculating the geometric properties includes using at least some of the data in the model of the anatomic part in addition to using at least some of the analytic-function parameter values.

3. The method as defined in claim 2, wherein the model of the anatomic part provides data about at least one three-dimensional surface of the anatomic part.

4. The method as defined in claim 2, wherein the model of the anatomic part provides data about at least one two-dimensional contour of the anatomic part.

5. The method as defined in claim 1, wherein at least one of the geometric properties is calculated using at least one virtual reference point that was calculated using at least one of the analytic-function parameter values.

6. The method as defined in claim 1, wherein at least one of the geometric properties is calculated using at least one previously-calculated geometric property.

7. The method as defined in claim 1, wherein the geometric properties include at least of morphologic information, morphometric information and clinical information.

8. The method as defined in claim 1, wherein the optimization technique in a nonlinear optimization technique.

9. The method as defined in claim 8, further comprising:
before performing the optimization technique, performing an initial optimization technique to obtain initial analytic-function parameter values of a plurality of initial basic-geometry items forming a simpler analytic geometry representation coarsely approximating the anatomic part, the simpler analytic geometry representation having less items than the subsequent analytic geometry representation, the initial analytic-function parameter values being computed until the initial basic-geometry items are positioned and proportioned within the simpler analytic geometry representation to substantially correspond to the anatomic part in the model; and
using at least some of the initial analytic-function parameter values to simplify the computing to obtain the analytic-function parameters of the subsequent analytic geometry representation.

10. The method as defined in claim 1, wherein the anatomic part is at least a portion of a bone.

11. The method as defined in claim 1, wherein the optimization includes at least one constraint to assist in a convergence of the optimization.

12. The method as defined in claim 1, wherein before the optimization, the model data is being subjected to at least one of a reorientation and a rearrangement to simplify the optimization.

13. The method as defined in claim 1, further comprising:
selecting the basic-geometry items in the analytic geometry representation before performing the optimization.

14. A system for carrying out a method for obtaining geometric properties of an anatomic part defined in a model, as shown and described herein.

15. A computer readable storage medium encoded with a computer program for controlling the operation of a system carrying out a method for obtaining geometric properties of an anatomic part defined in a model, as shown and described herein.
